(19) United States
(12) Patent Application Publication
(10) Pub. No.: US 2025/0181148 A1
(43) Pub. Date: Jun. 5, 2025

(54) CONTROL APPARATUS AND NON-TRANSITORY COMPUTER READABLE STORAGE MEDIUM

(71) Applicant: HONDA MOTOR CO., LTD., Tokyo (JP)

(72) Inventors: Ryotaro NISHIDA, Saitama (JP); Yoshikazu MATSUO, Tokyo (JP); Takafumi ENOMOTO, Tokyo (JP); Koya SAITO, Tokyo (JP); Kenji OKUMA, Tokyo (JP); Tatsumi SUZUKI, Saitama (JP)

(21) Appl. No.: 18/967,683

(22) Filed: Dec. 4, 2024

(30) Foreign Application Priority Data
Dec. 5, 2023 (JP) 2023-205415

(51) Int. Cl. G06F 3/01

(52) U.S. Cl. CPC G06F 3/012

(57) ABSTRACT

The control apparatus in an embodiment includes an estimator, an obtainer, and a definer. The estimator estimates the position of a person in a cabin of a vehicle. The obtainer obtains the position of an image displayed by a display apparatus that is installed in the vehicle and displays the image. The definer defines the display size of the image depending on the distance between the position of the face and the position of the image. The definer may reduce the display size as the distance is shorter.

This application is based on and claims the benefit of priority from Japanese Patent Application No. 2023-205415, filed on Dec. 5, 2023, the content of which is incorporated herein by reference.

### BACKGROUND OF THE INVENTION

### Field of the Invention

The present invention relates to a control apparatus, and a non-transitory computer readable storage medium.

### Related Art

There is a need for people in a vehicle to view a video during a break and the like. For this purpose, the vehicle includes a liquid crystal display in some cases. However, there is limited room for installing the liquid crystal display and the like in the cabin. Accordingly, it is desired to use a projector to display a large screen in the cabin.

For example, Patent Document 1 discloses a technique of controlling a height position of a place where a mobile projection apparatus projects an image, depending on the number of observers detected in an image taken by a camera. Note that the projection apparatus in Patent Document 1 is not a projector dedicated to a vehicle.
Patent Document 1: Japanese Unexamined Patent Application,

Publication No. 2022-174048

### SUMMARY OF THE INVENTION

As for the projector, in a case of a viewer viewing in a cabin of a vehicle, the distance from the face of the viewer to a screen is short, and visually induced motion sickness may occur depending on the projection size of the screen. According to the technique described in Patent Document 1, even if the height of the screen is changed depending on the number of people, visually induced motion sickness due to the projection size of the screen cannot be prevented.

An object of an embodiment in the present invention is to provide a control apparatus and a non-transitory computer readable storage medium that can make visually induced motion sickness less likely to occur.

A control apparatus in an embodiment includes an estimator, an obtainer, and a definer. The estimator estimates the position of a person in a cabin of a vehicle. The obtainer obtains the position of an image displayed by a display apparatus that is installed in the vehicle and displays the image. The definer defines the display size of the image depending on the distance between the position of the face and the position of the image.

According to an embodiment of the present invention, it is possible to make visually induced motion sickness less likely to occur.

### BRIEF DESCRIPTION OF THE DRAWINGS

FIG. 1 is a block diagram showing an example of main configurations of a projector system according to an embodiment and configuration elements included in this projector system;

FIG. 2 is a flowchart showing an example of processes by a processor of a control apparatus in FIG. 1; and

FIG. 3 is a flowchart showing an example of processes by the processor of the control apparatus in FIG. 1.

### DETAILED DESCRIPTION OF THE INVENTION

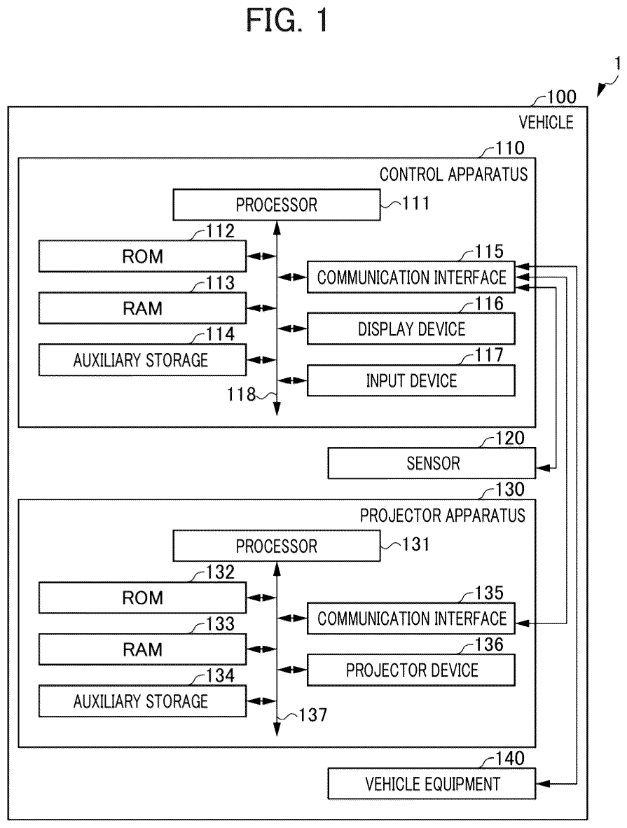

Hereinafter, a projector system according to an embodiment is described with reference to the drawings. Note that in the drawings used to describe the following embodiment, scales for the components may be changed as appropriate. In the drawings used to describe the following embodiment, components may be omitted for illustration purposes. In the drawings and this Specification, the same symbols indicate similar elements. FIG. 1 is a block diagram showing an example of main configurations of the projector system 1 according to the embodiment and configuration elements included in the projector system 1. Note that each configuration element in the apparatus may be embedded or external. The projector system 1 is a system that projects a video in a cabin of a vehicle 100. The projector system 1 is a system that defines the projection size of a projected video using the position of the face of a person in the cabin of the vehicle 100. The projector system 1 includes, for example, the vehicle 100.

The vehicle 100 is, for example, an automobile. Any type of automobile is allowed. The vehicle 100 includes, for example, a control apparatus 110, a sensor 120, a projector apparatus 130, and vehicle equipment 140. Note that the control apparatus 110 is not necessarily included in the vehicle 100. The projector apparatus 130 is not necessarily included in the vehicle 100.

The control apparatus 110 is an apparatus that can control the projector apparatus 130. The control apparatus 110 is, for example, a vehicle-mounted apparatus in the vehicle 100. The vehicle-mounted apparatus is, for example, an ECU (electronic control unit), a car navigation system, or an ETC (electronic toll collection) vehicle-mounted apparatus. The control apparatus 110 may be a smartphone, a tablet terminal, a PC (personal computer), or the like. Alternatively, the projector apparatus 130 may include the control apparatus 110. The control apparatus 110 includes, for example, a processor 111, a ROM (read-only memory) 112, a RAM (random-access memory) 113, an auxiliary storage 114, a communication interface 115, a display device 116, and an input device 117. A bus 118 or the like connects these components. The control apparatus 110 may include the sensor 120. Note that the control apparatus 110 is an example of a projection management apparatus.

The processor 111 is a center portion of a computer that performs processes such as computations, control and the like required to operate the control apparatus 110, and performs various computations, processes, and the like. The processor 111 may be, for example, a CPU (central processing unit), an MPU (micro processing unit), an SoC (system on a chip), a DSP (digital signal processor), a GPU (graphics processing unit), an ASIC (application specific integrated circuit), a PLD (programmable logic device), an FPGA (field-programmable gate array), or the like. Alternatively, the processor 111 may be a combination of multiple components among these. The processor 111 may be one that further includes a hardware accelerator or the like in combination with these. The processor 111 controls each component in order to achieve various functions of the control apparatus 110, based on programs such as firmware, system software and application software and the like stored in the ROM 112, the auxiliary storage 114, or the like. The processor 111 executes after-mentioned processes, based on the programs. Note that some or all of the programs may be implemented in the circuit of the processor 111.

The ROM 112 and the RAM 113 are a main memory of the computer centered at the processor 111. The ROM 112 is a non-volatile memory used to read data in a dedicated manner. The ROM 112 stores, for example, firmware and the like among the programs described above. The ROM 112 also stores data and the like that the processor 111 uses for performing various processes.

The RAM 113 is a memory used to read and write data. The RAM 113 is used as a work area and the like for storing data that the processor 111 temporarily uses for performing various processes. Typically, the RAM 113 is a volatile memory.

The auxiliary storage 114 is an auxiliary storage of the computer centered at the processor 111. The auxiliary storage 114 is, for example, an EEPROM (electric erasable programmable read-only memory), an HDD (hard disk drive), a flash memory, or the like. The auxiliary storage 114 stores, for example, the system software, the application software, and the like among the programs described above. The auxiliary storage 114 stores data that the processor 111 uses for performing various processes, data generated by the processes in the processor 111, various setting values, and the like.

The communication interface 115 is an interface for allowing the control apparatus 110 to communicate with another apparatus. The communication may be wireless communication or wired communication. The communication may be wireless communication and wired communication in a mixed manner. The control apparatus 110 communicates with the sensor 120, the projector apparatus 130, and the vehicle equipment 140 via the communication interface 115. The control apparatus 110 controls the projector apparatus 130 using communication with the projector apparatus 130.

The display device 116 displays a screen for notifying various types of information to an operator or the like of the vehicle 100 or the control apparatus 110. The display device 116 is, for example, a display such as a liquid crystal display or an organic EL (electro-luminescence) display.

The input device 117 accepts an operation by the operator of the vehicle 100 or the control apparatus 110. The input device 117 is, for example, a keyboard, a keypad, a touch pad, a controller, or the like. The input device 117 may be a device for audio input. A touch panel may be used as the display device 116 and the input device 117. In this case, a display panel included in the touch panel functions as the display device 116. A touch-input type pointing device included in the touch panel functions as the input device 117.

The bus 118 includes a control bus, an address bus, a data bus, and the like, and transfers signals exchanged between the components of the control apparatus 110.

The sensor 120 is a sensor installed in the vehicle 100. The sensor 120 is a sensor used to estimate the position of the face of an occupant of the vehicle 100. The sensor 120 is, for example, a camera, an infrared sensor, a radar, an LIDAR (light detection and ranging), etc. The sensor 120 outputs sensor information. The sensor information is information that includes measurement results by the sensor 120. In a case where the sensor 120 is a camera, the sensor information includes an image taken by the camera. Note that a moving image is a type of the image. In the vehicle 100, a plurality of sensors 120 may be installed. In the vehicle 100, multiple types of sensors 120 may be installed.

The projector apparatus 130 is also called a projector. The projector apparatus 130 is an apparatus that projects an image on a projection object by projecting light. In the embodiment, the projection object is at any site in the cabin of the vehicle 100. Examples of a projection destination of the image include a ceiling, a wall, a door, and a floor, the back of a backrest of a seat, window glass, a dashboard, and the like in the cabin of the vehicle 100. For example, the projector apparatus 130 is placed in the vehicle 100 and is used. For example, the projector apparatus 130 is installed in the vehicle 100. The projector apparatus 130 may be preliminarily equipped in the vehicle 100. For example, the projector apparatus 130 is installed between a seat and a seat that are rear seats. Note that the projector apparatus 130 is an example of a display apparatus that displays an image.

The projector apparatus 130 includes, for example, a processor 131, a ROM 132, a RAM 133, an auxiliary storage 134, a communication interface 135, and a projector device 136. A bus 137 or the like connects these components.

The processor 131 is a center portion of a computer that performs processes such as computations, control, and the like required to operate the projector apparatus 130, and performs various computations, processes, and the like. The processor 131 is, for example, a CPU, an MPU, an SoC, a DSP, a GPU, an ASIC, a PLD, an FPGA, or the like. Alternatively, the processor 131 may be a combination of multiple components among these. The processor 131 may be one that further includes a hardware accelerator or the like in combination with these. The processor 131 controls each component in order to achieve various functions of the projector apparatus 130, based on programs such as firmware, system software and application software stored in the ROM 132, the auxiliary storage 134, or the like. The processor 131 executes after-mentioned processes, based on the programs. Note that some or all of the programs may be implemented in the circuit of the processor 131.

The ROM 132 and the RAM 133 are a main memory of a computer centered at the processor 131. The ROM 132 is a non-volatile memory used to read data in a dedicated manner. The ROM 132 stores, for example, firmware and the like among the programs described above. The ROM 132 also stores data and the like that the processor 131 uses for performing various processes.

The RAM 133 is a memory used to read and write data. The RAM 133 is used as a work area and the like for storing data that the processor 131 temporarily uses for performing various processes. Typically, the RAM 133 is a volatile memory.

The auxiliary storage 134 is an auxiliary storage of the computer centered at the processor 131. The auxiliary storage 134 is, for example, an EEPROM, an HDD, a flash memory, or the like. The auxiliary storage 134 stores, for example, the system software, the application software, and the like among the programs described above. The auxiliary storage 134 stores data that the processor 131 uses for performing various processes, data generated by the processes in the processor 131, various setting values, and the like.

The communication interface 135 is an interface for allowing the projector apparatus 130 to communicate with another apparatus. The communication may be wireless communication or wired communication. The communication may be wireless communication and wired communication in a mixed manner. The projector apparatus 130 communicates with the control apparatus 110 via the communication interface 135.

The projector device 136 is a display apparatus that projects an image on a projection object by projecting light. The projector device 136 includes, for example, a light source and a lens. The light source emits light. The lens projects light onto the projection object. Preferably, the projector device 136 can change the projection position and the projection direction of an image.

The bus 137 includes a control bus, an address bus, a data bus, and the like, and transfers signals exchanged between each component of the projector apparatus 130.

The vehicle equipment 140 is equipment included in the vehicle 100. The vehicle equipment 140 includes, for example, power windows. The power windows are windows that can be opened and closed by electric control.

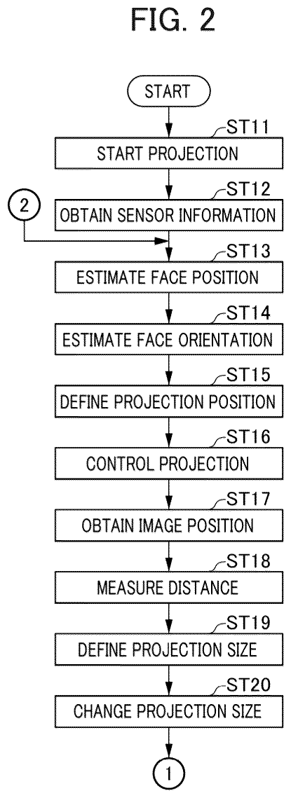

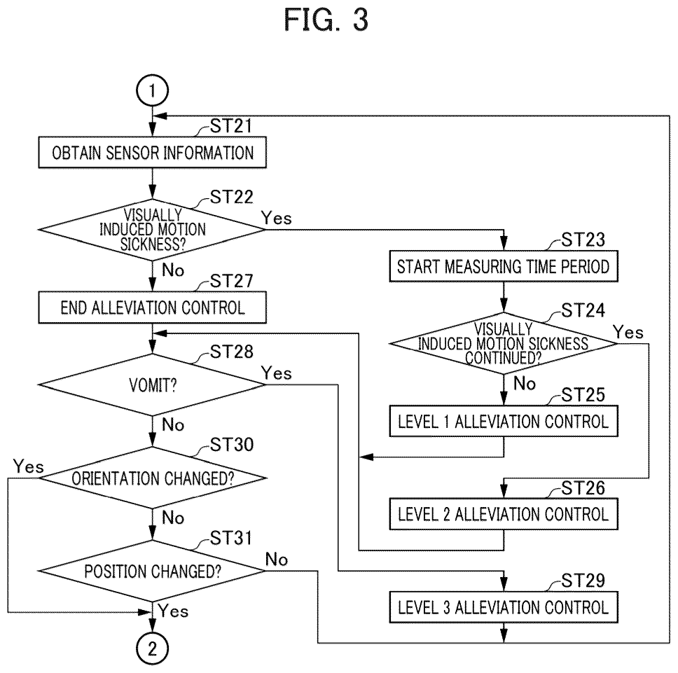

Hereinafter, the operation of the projector system 1 according to the embodiment is described with reference to FIGS. 2 and 3 and the like. Note that the content of the processes in after-mentioned description of the operation is an example. Various processes that can obtain a similar result can be appropriately used. FIGS. 2 and 3 are flowcharts showing an example of processes by the processor 111 of the control apparatus 110. The processor 111 executes processes in FIGS. 2 and 3, based on, for example, the program stored in the ROM 112, the auxiliary storage 114, or the like.

The processor 111 of the control apparatus 110 starts the processes in FIGS. 2 and 3 when control of the projector apparatus 130 is started, for example.

In step ST11 in FIG. 2, the processor 111 of the control apparatus 110 instructs the projector apparatus 130 to start to project an image. In response to the instruction, the projector apparatus 130 controls the projector device 136 to start to project the image. The projector device 136 starts to project the image, based on the control.

In step ST12, the processor 111 obtains sensor information from the sensor 120.

In step ST13, the processor 111 estimates the position of the face of the viewer using the sensor information obtained in step ST12. Here, the viewer is a person who views an image projected by the projector apparatus 130 among people in the vehicle 100. Preferably, the processor 111 estimates the positions of the eyes of the viewer. The processor 111 then assumes the positions of the eyes as the position of the face of the viewer. Alternatively, the processor 111 may assume the position of the head as the position of the face. In a case where the sensor information includes an image obtained by imaging the inside of the cabin, the processor 111 estimates the position of the face of the viewer by image analysis of the image where the viewer is taken, for example. Note that the processor 111 may estimate the position of the face of the viewer multiple times in a certain time period. The processor 111 may then calculate the average of positions of the face of the viewer estimated multiple times, and adopt the calculation result as an estimation result in step ST13. Alternatively, the processor 111 may adopt the position with the highest frequency among the positions of the face of the viewer estimated multiple times, and assume the adopted one as an estimation result in step ST13. Preferably, in the case of estimating the position of the face of the viewer multiple times, the processor 111 preliminarily, repetitively estimates the position of the face of the viewer in the background of another process, instead of estimating the position of the face of the viewer multiple times after starting the process in step ST13.

Note that in a case where there are multiple viewers, the processor 111 estimates the position of the face of any one viewer as a target. Alternatively, the processor 111 estimates the positions of the faces of all the viewers as targets. Alternatively, the processor 111 may calculate the average of the positions of the faces of multiple viewers.

As described above, the processor 111 functions as an example of an estimator that estimates the position of the face of a person in the cabin of the vehicle, by performing the process in step ST13.

In step ST14, the processor 111 estimates the orientation of the face of the viewer using the sensor information obtained in step ST12. The processor 111 may estimate the orientation of the face also using the position of the face of the viewer estimated in step ST13. The processor 111 estimates the orientation of the face by detecting a portion of the face, for example. In the case where the sensor information includes an image obtained by imaging the inside of the cabin, the processor 111 estimates the orientation of the face of the viewer by image analysis of the image where the viewer is taken, for example. Note that the processor 111 may estimate the orientation of the face of the viewer multiple times in a certain time period. The processor 111 may then calculate the average of orientations of the face of the viewer estimated multiple times, and adopt the calculation result as an estimation result in step ST14. Alternatively, the processor 111 may adopt the orientation with the highest frequency among the orientations of the face of the viewer estimated multiple times, and assume the adopted one as an estimation result in step ST14. Preferably, in the case of estimating the orientation of the face of the viewer multiple times, the processor 111 preliminarily, repetitively estimates the orientation of the face of the viewer in the background of another process, instead of estimating the orientation of the face of the viewer multiple times after starting the process in step ST14.

Note that in the case where there are multiple viewers, the processor 111 estimates the orientation of the face of any one viewer as a target. Alternatively, the processor 111 estimates the orientations of the faces of all the viewers as targets. Alternatively, the processor 111 may calculate the average of the orientations of the faces of multiple viewers.

As described above, the processor 111 functions as an example of an estimator that estimates the orientation of the face of the person, by performing the process in step ST14.

In step ST15, the processor 111 defines the optimal projection position depending on the orientation of the face of the viewer. Here, the optimal projection position is, for example, the position at which the probability of causing visually induced motion sickness is lowest. The processor 111 defines, for example, an extended line indicated by the orientation of the face of the viewer, as the optimal projection position. The processor 111 assumes, for example, a point at which the extended line of a vector indicating the orientation of the face of the viewer intersects with any point on the vehicle 100, as the center of the projected image. The starting point of the vector is, for example, the position of the face of the viewer. Note that the center is, for example, the barycenter. Typically, the image projected by the projector is a rectangle. The center of the rectangle coincides with the intersection of the diagonals.

Note that in the case where there are multiple viewers, the processor 111 defines the optimal projection position using the orientation of the face of any one of the viewers. Alternatively, the processor 111 defines the optimal projection position using the average of the orientations of the faces of multiple viewers.

As described above, the processor 111 functions as an example of a definer that defines the display position of the image depending on the orientation of the face, by performing the process in step ST15.

In step ST16, the processor 111 controls the projector apparatus 130 to project an image at the projection position defined in step ST15. The projector apparatus 130 controls the projector device 136, based on the control, and changes the projection position of the image.

In step ST17, the processor 111 obtains the position of the projected image. The processor 111 obtains the position of the center of the image as the position of the image. For example, the processor 111 obtains the position of the image by estimating the position of the center. For example, the processor 111 estimates the position of the image using the sensor information obtained in step ST12. In the case where the sensor information includes an image obtained by imaging the inside of the cabin, the processor 111 estimates the position of the image by image analysis of the image where the viewer is taken, for example. Note that the projector apparatus 130 may have a function of measuring the position of the image. In this case, the processor 111 may obtain the position of the image from the projector apparatus 130.

As described above, the processor 111 functions as an example of an obtainer that obtains the position of the image displayed by the display apparatus that is installed in the vehicle and displays the image, by performing the process in step ST17.

In step ST18, the processor 111 estimates the viewing distance of the viewer. That is, the processor 111 estimates the distance between the position of the face estimated in step ST13 and the position of the image obtained in step ST17. For example, the processor 111 estimates the distance by calculating the norm of the difference of the position vector indicating the position of the face and the position vector indicating the position of the image.

Note that in the case where there are multiple viewers, the processor 111 estimates the viewing distance, with any one viewer being adopted as a target. Alternatively, the processor 111 estimates the viewing distances, with all the viewers being adopted as targets. Alternatively, the processor 111 estimates the viewing distance using the average of positions of the faces of multiple viewers.

In step ST19, the processor 111 defines the optimal projection size depending on the viewing distance. Here, the optimal projection size is, for example, the largest size with which the probability of causing visually induced motion sickness is a predetermined one or lower. The processor 111 defines the projection size according to, for example, the following expression. Note that the projection size is the length of a predetermined portion of the projected image. If the projected image is a rectangle, the predetermined portion is, for example, is a diagonal of the rectangle.

(projection size)=(predetermined coefficient)×(viewing distance) (1)

Here, the predetermined coefficient is a predefined value. The predetermined coefficient can also be called the projection size in a case where the viewing distance is a unit distance. The value of the predetermined coefficient is defined by, for example, a designer, a seller, or a manager of the projector system 1. The value of the predetermined coefficient may be changed by an operator of the control apparatus 110, an operator of the projector apparatus 130, or the like.

Note that the expression for determining the projection size is not limited to the expression described above. Alternatively, the expression for determining the projection size may be nonlinear.

In a case where the processor 111 estimates a plurality of viewing distances in step ST18, this processor defines the projection size using the viewing distance for any one person. In the case where the processor 111 estimates a plurality of viewing distances in step ST18, this processor defines the projection size using the average of these viewing distances.

As described above, the processor 111 functions as an example of the definer that defines the display size of the image depending on the distance between the position of the face and the position of the image, by performing the process in step ST19.

In step ST20, the processor 111 controls the projector apparatus 130 to project an image with the projection size defined in step ST19. The projector apparatus 130 controls the projector device 136, based on the control, and changes the projection size of the image.

In step ST21 in FIG. 3, the processor 111 obtains sensor information from the sensor 120.

In step ST22, the processor 111 determines whether the viewer has visually induced motion sickness or not. The processor 111 determines whether the viewer has visually induced motion sickness or not using, for example, the sensor information obtained in step ST21. In the case where the sensor information includes an image obtained by imaging the inside of the cabin, the processor 111 determines whether the viewer has visually induced motion sickness or not by, for example, image analysis of the image in which the viewer is taken. The processor 111 determines whether the viewer has visually induced motion sickness or not using, for example, at least one of presence or absence of yawns of the viewer, the number and frequency of these, color of the face, presence or absence and an amount of cold sweats, presence or absence of motions of swallowing saliva, the number and frequency of these, and expression. Note that in a case of determining whether the viewer has visually induced motion sickness or not using the color of the face of the viewer, the processor 111 determines whether the viewer has visually induced motion sickness or not using, for example, whether the viewer has facial pallor or not. The number of motions of swallowing saliva increases as the saliva increases. Note that in a case of determining whether the viewer has visually induced motion sickness or not using the expression of the viewer, the processor 111 determines whether the viewer has visually induced motion sickness or not using, for example, change in expression due to discomforts, such as nausea, of the viewer. Note that determination of presence or absence of visually induced motion sickness may be determination that the viewer has visually induced motion sickness even in case the viewer has motion sickness in actuality instead of visually induced motion sickness. In the case of determination that the viewer has visually induced motion sickness, the processor 111 determines Yes in step ST22 and proceeds the processing to step ST23. Note that in the case of multiple viewers, the processor 111 determines Yes in step ST22 if one or more viewers have visually induced motion sickness. Alternatively, if the number of people causing visually induced motion sickness is a predetermined number or more, the processor 111 determines Yes in step ST22.

As described above, the processor 111 functions as an example of a determiner that determines that the person in the cabin of the vehicle has visually induced motion sickness by performing the process in step ST22.

In step ST23, the processor 111 starts to measure the time period during which the viewer has visually induced motion sickness. Note that if the processor 111 is already measuring the time period, this processor skips the process in step ST23.

In step ST24, the processor 111 determines whether or not the viewer has continuously had visually induced motion sickness for a predetermined period or longer. If the time period after start of measurement in step ST23 is a predetermined time period T1 or longer, the processor 111 determines that the visually induced motion sickness of the viewer continues for the predetermined period or longer. If the visually induced motion sickness of the viewer does not continue for the predetermined period or longer, the processor 111 determines No in step ST24, and proceeds the processing to step ST25.

In step ST25, the processor 111 starts control (hereinafter called “alleviation control”) of alleviating visually induced motion sickness due to a projected video. The alleviation control may have a plurality of levels. The level of the alleviation control indicates that the higher the level is, the larger the degree of alleviation of visually induced motion sickness. In step ST25, the processor 111 starts level 1 alleviation control, for example. Note that during level 2 alleviation control or higher, the processor 111 ends the level 2 alleviation control or higher, and starts the level 1 alleviation control.

For example, the alleviation control includes three stages from the level 1 to the level 3. As an example of the alleviation control in levels 1 to 3, (A1) to (A8) are described below.

### (A1)

Level 1: The processor 111 controls the projector apparatus 130 to reduce the projection size of the image. Level 2: The processor 111 controls the projector apparatus 130 to make the projection size of the image smaller than that in the lower level. Level 3: The processor 111 controls the projector apparatus 130 to end projecting the image.

### (A2)

Level 1: The processor 111 controls the vehicle equipment 140 to open the power windows. Level 2: The processor 111 controls the projector apparatus 130 to reduce the projection size of the image. Level 3: The processor 111 controls the projector apparatus 130 to end projecting the image.

Level 1: The processor 111 controls the projector apparatus 130 to reduce the projection size of the image. Level 2: The processor 111 controls the projector apparatus 130 to make the projection size of the image smaller than that in the lower level. Level 3: The processor 111 controls the projector apparatus 130 to make the projection size of the image smaller than that in the lower level.

### (A4)

Level 1: The processor 111 controls the projector apparatus 130 to reduce the projection size of the image. Level 2: The processor 111 controls the projector apparatus 130 to end projecting the image. Level 3: The processor 111 controls the vehicle equipment 140 to open the power windows.

### (A5)

Level 1: The processor 111 controls the projector apparatus 130 to change the content of the projected image to what is unlikely to have sickness. Level 2: The processor 111 controls the projector apparatus 130 to reduce the projection size of the image. Level 3: The processor 111 controls the projector apparatus 130 to end projecting the image.

Level 1: The processor 111 controls the projector apparatus 130 to change the content of the projected image to what is unlikely to have sickness. Level 2: The processor 111 controls the projector apparatus 130 to reduce the projection size of the image. Level 3: The processor 111 controls the projector apparatus 130 to make the projection size of the image smaller than that in the lower level.

### (A7)

Level 1: The processor 111 controls the projector apparatus 130 to change the content of the projected image to what is unlikely to have sickness. Level 2: The processor 111 controls the vehicle equipment 140 to open the power windows. Level 3: The processor 111 controls the projector apparatus 130 to reduce the projection size of the image.

### (A8)

Level 1: The processor 111 controls the projector apparatus 130 to change the content of the projected image to what is unlikely to have sickness. Level 2: The processor 111 controls the vehicle equipment 140 to open the power windows. Level 3: The processor 111 controls the projector apparatus 130 to end projecting the image.

Note that the alleviation control in levels 1 to 3 may be such that includes control details in levels 1 to 3 in the example described above that are replaced with each other. The control details in levels 1 and 2 may be the same. The control details in levels 2 and 3 may be the same. All the control details in levels 1 to 3 may be the same. The alleviation control in levels 1 to 3 may be alleviation control where the level 2 in the example described above is the same as the level 1. The alleviation control in levels 1 to 3 may be alleviation control where the level 1 in the example described above is the same as the level 2. The alleviation control in levels 1 to 3 may be alleviation control where the level 3 in the example described above is the same as the level 2. The alleviation control in levels 1 to 3 may be alleviation control where the level 2 in the example described above is the same as the level 3.

The processor 111 may perform multiple instances of control in one level. For example, the level that includes control of reducing the projection size of the image may also include control of opening the power windows. The level that includes control of ending projecting the image may also include control of opening the power windows. The level for changing the content of the projected image may also include control of opening the power windows. The level that includes control of reducing the projection size of the image may also include control of changing the content of the projected image to what is unlikely to have sickness.

As described above, the processor 111 functions as an example of a controller that controls the display apparatus that displays the image to reduce the display size of the image or end displaying, by performing the alleviation control, in case a person has visually induced motion sickness or vomits. The processor 111 functions as an example of a controller that opens the windows of the vehicle in case a person has visually induced motion sickness, by performing the process in step ST25.

On the other hand, if the visually induced motion sickness of the viewer continues for a predetermined period or longer, the processor 111 determines Yes in step ST24 and proceeds the processing to step ST26.

In step ST26, the processor 111 starts alleviation control. In step ST26, the processor 111 starts level 2 alleviation control, for example. Note that during level 3 alleviation control or higher, the processor 111 ends the level 3 alleviation control or higher, and starts the level 2 alleviation control.

As described above, the processor 111 functions as an example of a controller that reduces the display size of the image or ends displaying, by performing the process in step ST26, if the visually induced motion sickness of the person continues for the predetermined period or longer.

If the processor 111 does not determine that the viewer has visually induced motion sickness, this processor determines No in step ST22 and proceeds the processing to step ST27.

In step ST27, the processor 111 ends the alleviation control.

After the process in step ST25, step ST26, or step ST27, the processor 111 proceeds the processing to step ST28.

In step ST28, the processor 111 determines whether the viewer vomits or not. The processor 111 determines whether the viewer vomits or not using, for example, the sensor information obtained in step ST21. In the case where the sensor information includes an image obtained by imaging the inside of the cabin, the processor 111 determines whether the viewer vomits or not by, for example, image analysis of the image in which the viewer is taken. If the processor 111 determines that the viewer vomits, this processor determines Yes in step ST28 and proceeds the processing to step ST29.

As described above, the processor 111 functions as an example of a determiner that determines that the person in the cabin of the vehicle vomits, by performing the process in step ST28.

In step ST29, the processor 111 starts alleviation control. In step ST29, the processor 111 starts level 3 alleviation control, for example. The processor 111 may end the process in step ST29 after continuing the level 3 alleviation control for a predetermined period or longer. The processor 111 may end the level 3 alleviation control when ending the processing in step ST29. If the processor 111 ends the level 3 alleviation control, this processor may start the level 1 or 2 alleviation control. After the process in step ST29, the processor 111 returns the processing to step ST21.

If the viewer does not vomit, the processor 111 determines No in step ST28 and proceeds the processing to step ST30.

In step ST30, the processor 111 determines whether or not the orientation of the face of the viewer changes by a predetermined degree or more. Similar to step ST14, the processor 111 estimates the orientation of the face of the viewer using, for example, the sensor information obtained in step ST21. In this case, similar to step ST13, the processor 111 may estimate the position of the face of the viewer. If the orientation of the face estimated in step ST14 and the orientation of the face estimated in step ST30 are different by a predetermined amount or more, the processor 111 determines that the orientation of the face of the viewer changes by a predetermined amount or more. Alternatively, if the time period during which the orientation of the face estimated in step ST14 and the orientation of the face estimated in step ST30 are different by the predetermined amount or more continues for a predetermined period or longer, the processor 111 determines that the orientation of the face of the viewer changes by the predetermined amount or more. If the orientation of the face of the viewer does not change by the predetermined amount or more, the processor 111 determines No in step ST30 and proceeds the processing to step ST31.

If the orientation of the face of the viewer changes by the predetermined amount or more, the processor 111 determines Yes in step ST30 and returns the processing to step ST13. Accordingly, the processor 111 performs the processes in steps ST13 to ST20 again. By the processes steps ST13 to ST20 performed again, the projection position and the projection size are changed to the optimal projection position and projection size depending on the changed orientation of the face.

In step ST31, the processor 111 determines whether or not the position of the face of the viewer changes by a predetermined degree or more. Similar to step ST13, the processor 111 estimates the position of the face of the viewer using, for example, the sensor information obtained in step ST21. Alternatively, the processor 111 may use the position of the face estimated in step ST30. If the position of the face estimated in step ST13 and the position of the face estimated in step ST30 or ST31 are different by the predetermined amount or more, the processor 111 determines that the position of the face of the viewer changes by the predetermined amount or more. Alternatively, if the time period in which the position of the face estimated in step

ST13 and the position of the face estimated in step ST30 or ST3 are different by the predetermined amount or more continues for a predetermined period or longer, the processor 111 determines that the position of the face of the viewer changes by the predetermined amount or more. If the processor 111 does not determine that the position of the face of the viewer changes by the predetermined amount or more, this processor determines No in step ST31 and returns the processing to step ST21. As described above, the processor 111 repeats the processes in steps ST21 to ST31, and starts the alleviation control if the viewer has visually induced motion sickness, the visually induced motion sickness of the viewer continues for the predetermined period or longer, or the viewer vomits.

If the processor 111 determines that the position of the face of the viewer changes by the predetermined amount or more, this processor determines Yes in step ST31 and returns the processing to step ST13. Note that if the processor 111 returns the processing from step ST31 to step ST13, this processor skips the processes steps ST14 to ST16. That is, after the process in step ST13, the processor 111 proceeds the processing to step ST17. Thus, the processor 111 performs the processes in steps ST12 to ST13 and steps ST17 to ST20 again. By the processes in steps ST12 to ST 13 and steps ST17 to ST20 performed again, the projection size is changed to the optimal projection size depending on the changed position of the face.

According to the projector system 1 in the embodiment, the control apparatus 110 estimates the position of the face in the cabin of the vehicle 100. The control apparatus 110 in the embodiment obtains the position of the image projected by the projector apparatus 130. The control apparatus 110 in the embodiment defines the projection size of the image depending on the distance between the position of the face and the position of the image. Accordingly, the control apparatus 110 in the embodiment can determine the optimal projection size depending on the distance. The optimal projection size is, for example, the projection size with which the probability of causing visually induced motion sickness is a predetermined one or lower. Accordingly, people in the cabin are unlikely to have visually induced motion sickness.

According to the projector system 1 in the embodiment, the control apparatus 110 reduces the projection size of the image as the distance is shorter. Visually induced motion sickness is more likely to occur as the appearance size is large. Accordingly, the control apparatus 110 in the embodiment makes visually induced motion sickness less likely to occur by reducing the projection size as the distance decreases.

According to the projector system 1 in the embodiment, the control apparatus 110 adopts the center of the projected image as the position of the image. Accordingly, the control apparatus 110 in the embodiment can correctly grasp the position of the image.

According to the projector system 1 in the embodiment, the control apparatus 110 estimates the orientation of the face in the cabin of the vehicle 100. The control apparatus 110 in the embodiment then defines the projection position of the image depending on the orientation of the face. The control apparatus 110 in the embodiment aligns the position of the projection position to the orientation of the face, which can prevent people in the cabin from having visually induced motion sickness.

According to the projector system 1 in the embodiment, the control apparatus 110 determines at least one of visually induced motion sickness and vomiting of the person in the cabin of the vehicle 100. In case the person in the cabin has visually induced motion sickness or vomits, the control apparatus 110 in the embodiment reduces the projection size of the image projected by the projector apparatus 130 or ends the projection. Accordingly, the control apparatus 110 in the embodiment can alleviate the visually induced motion sickness due to the projected video.

According to the projector system 1 in the embodiment, the control apparatus 110 opens the power windows in case the person in the cabin of the vehicle 100 has visually induced motion sickness. If visually induced motion sickness of the person in the cabin continues for the predetermined period or longer, the control apparatus 110 in the embodiment reduces the projection size of the image projected by the projector apparatus 130 or ends the projection. Accordingly, the control apparatus 110 in the embodiment can alleviate the visually induced motion sickness due to the projected video.

The embodiment can be modified as follows. In the embodiment described above, the alleviation control includes the three stages from the level 1 to the level 3. However, the alleviation control may include four or more stages. In this case, for example, if the time period of which measurement has started in step ST23 is a predefined time period T2 or longer, the processor starts alleviation control higher than the level 2 and lower than the level 3. Note that the time period T2 is a time period longer than the time period T1.

In the embodiment described above, the control apparatus 110 defines and changes the projection size on the basis of the position of the face of the viewer, and defines and changes the projection position on the basis of the orientation of the face of the viewer. However, the control apparatus 110 in the embodiment may perform only any one of these.

In the embodiment described above, the projector apparatus 130 projects the image, thus displaying the image. However, the projector system in the embodiment may include a display apparatus other than the projector, instead of the projector apparatus 130. The display apparatus may be, for example, a display. The display may be a head-up display or a head-mounted display. The head-mounted display may be a VR (virtual reality) goggle.

In the embodiment described above, the projector apparatus 130 is installed in the vehicle 100. However, the embodiment described above may also be applied to the projector apparatus 130 installed other than inside of the vehicle 100.

Each apparatus in the embodiment may be made up of a plurality of apparatuses.

The processor 111 and the processor 131 may achieve some or all of the processes implemented by the program in the aforementioned embodiment by hardware configurations of circuits.

The program that implements the processes of the embodiment is transferred, for example, in a state of being stored in a non-transitory computer readable storage medium in the apparatus. However, the apparatus may be transferred in a state of not storing the program. The program may then be separately transferred and be written into the apparatus. The transfer of the program in this case can be achieved by recording it in a removable non-transitory computer readable storage medium, or by downloading it via a network, such as the Internet or a LAN (local area network).

Embodiments of the present invention are thus described above, but are described as examples, and do not limit the scope of the present invention. The embodiments of the present invention can be implemented in various modes in a range without departing from the gist of the present invention.

### EXPLANATION OF REFERENCE NUMERALS

1 Projector system
100 Vehicle
110 Control apparatus
111, 131 Processor
112, 132 ROM
113, 133 RAM
114, 134 Auxiliary storage
115, 135 Communication interface
116 Display device
117 Input device
118, 137 Bus
120 Sensor
130 Projector apparatus
136 Projector device
140 Vehicle equipment

What is claimed is:

1. A control apparatus, comprising:
an estimator configured to estimate a position of a face of a person in a cabin of a vehicle;
an obtainer configured to obtain a position of an image displayed by a display apparatus that is installed in the vehicle and displays the image; and
a definer configured to define a display size of the image depending on a distance between the position of the face and the position of the image.

2. The control apparatus according to claim 1, wherein the definer reduces the display size as the distance is shorter.

3. The control apparatus according to claim 1, wherein the position of the image is at a center of the image.

4. The control apparatus according to claim 1, wherein
the estimator estimates an orientation of the face, and
the definer defines a display position of the image depending on the orientation of the face.

5. A control apparatus, comprising:
a determiner configured to determine at least any of visually induced motion sickness and vomiting of a person in a cabin of a vehicle; and
a controller configured to control a display apparatus that displays an image, and to reduce a display size of the image or to end displaying, in case of the visually induced motion sickness or the vomiting of the person.

6. The control apparatus according to claim 5, wherein the controller opens a window of the vehicle in case of the visually induced motion sickness of the person, and reduces the display size of the image or ends displaying if the visually induced motion sickness of the person continues for a predetermined period or longer.

7. A non-transitory computer readable storage medium storing a program causing a processor included in a control apparatus to function as:
an estimator configured to estimate a position of a face of a person in a cabin of a vehicle;
an obtainer configured to obtain a position of an image displayed by a display apparatus that is installed in the vehicle and displays the image; and
a definer configured to define a projection size of the image depending on a distance between the position of the face and the position of the image.

8. A non-transitory computer readable storage medium storing a program causing a processor included in a control apparatus to function as:
a determiner configured to determine visually induced motion sickness or vomiting of a person in a cabin of a vehicle; and
a controller configured to control a display apparatus that displays an image, and to reduce a display size of the image or to end displaying, in case of the visually induced motion sickness or the vomiting of the person.
